(19) United States
(12) Patent Application Publication
(10) Pub. No.: US 2019/0354960 A1
(43) Pub. Date: Nov. 21, 2019

(54) MANAGING USER MEMBERSHIP ACCOUNTS

(71) Applicant: GOOGLE INC., Mountain View, CA (US)

(72) Inventors: Joshua Abraham Tabak, San Francisco, CA (US); Christyn Courtney, San Francisco, CA (US)

(21) Appl. No.: 14/468,302

(22) Filed: Aug. 25, 2014

Related U.S. Application Data
(60) Provisional application No. 61/981,178, filed on Apr. 17, 2014.

(51) Int. Cl. G06Q 20/36; G06Q 10/06; G06Q 30/02

(52) U.S. Cl. CPC G06Q 20/363; G06Q 30/0226; G06Q 10/06

(57) ABSTRACT

A membership management system automatically manages user account memberships for a user. Based on information that the user provides to the membership management system, for example, the membership management system determines a user identifier for the user, such as a telephone number. The membership management system then communicates the user identifier to a merchant, which identifies membership account information for the user from the user identifier. For example, the membership management system employs the user's telephone number to identify an account of the user such as loyalty account. The merchant then provides the user's membership information to the membership management system, which then associates the user's membership information with a record for the user. By repeating this process, for example, the membership management system can—on behalf of the user—automatically associate multiple user membership accounts with a user record, such as a digital wallet of the user.

### CROSS-REFERENCE TO RELATED APPLICATIONS

This patent application claims priority to U.S. Provisional Patent Application No. 61/981,178, filed Apr. 17, 2014, and entitled “Managing User Membership Accounts.” The entire disclosure of the above-identified priority application is hereby fully incorporated herein by reference.

### TECHNICAL FIELD

The present disclosure relates generally to managing user membership accounts, and more particularly to automatically updating an account of a user, such as a digital wallet of the user, to include one or more user account memberships of the user.

### BACKGROUND

As users shop online or in a merchant store, users often create account memberships with the merchant. Such account memberships provide numerous benefits to both the user and the merchant. For example, certain discount or volume merchants may only allow members to shop at the merchant. The merchant may also rely on the user's purchasing activity associated with the account to determine what specific offers or promotions may be of interest to the user. The merchant can then provide the offers or promotions to the user, and the user can redeem the offers or promotions at the merchant. The user may also rely on an account membership, such as a loyalty account membership, as a record for specific purchase transactions with the merchant. The user then does not have to keep a paper receipt of transactions with the merchant.

Because of such benefits, user account memberships have become very popular, and many users accumulate numerous account memberships with different merchants. But keeping track of all the user's memberships, such as loyalty account memberships, can be challenging. If the user desires to store his or her many accounts in one place—such as in a digital wallet—the user must conventionally add or scan each membership account manually in to the digital wallet account. Not only is such manual entry time consuming, but it also leads to user errors and/or omissions. For example, users oftentimes do not remember all of their account memberships or have their account information handy. And in many instances, a user may not even know his or her membership account number. Hence, the user may neglect to add various membership account numbers to their digital wallet account.

### SUMMARY

In certain example aspects described herein, a computer-implemented method for membership account management is provided. A user, for example, creates a record, such as a digital wallet account, with a membership management system. The membership management system then determines an identifier, such as a telephone number, associated with the user record. In response to determining the user identifier and on behalf of the user, the membership management system then automatically determines one or more membership accounts of the user, such as a loyalty account. For example, the membership management system communicates the user identifier to one or more merchant computing systems that is separate from the membership management system. In response to communicating the user identifier to the one or more merchant computing systems, the membership management system receives one or more membership records for the user. Each of the received one or more membership records, for example, corresponds to a particular merchant membership account of the user. After receiving the one or more membership records, the loyalty account management system associates—on behalf of the user—each of the one or more received loyalty membership records for the user with the user record of the user.

In certain other example aspects, a system for membership account management is provided herein. Also provided in certain aspects is a computer program product for user membership account management.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for managing a membership account of a user, in accordance with certain example embodiments.

FIG. 2 is a block flow diagram depicting a method for automatically associating a user account with a record for the user, in accordance with certain example embodiments.

FIG. 3 is a block flow diagram depicting a method for receiving a user account record of a user, in accordance with certain example embodiments.

FIG. 4 is a block diagram depicting a computing machine and a module, in accordance with certain example embodiments.

### DETAILED DESCRIPTION OF THE EXAMPLE EMBODIMENTS

Overview

As disclosed herein, a membership management system automatically manages, at a user's request, account memberships for the user. Based on information that a user provides to the membership management system, the membership management system determines one or more user identifiers for the user. The membership management system then communicates the user identifier to a merchant, which identifies membership information for the user, such as a loyalty membership account number. The merchant then provides the user's membership information to the membership management system, which then associates the user's membership information with a record for the user. By repeating this process, for example, the membership management system can—on behalf of the user—automatically associate multiple user membership accounts with a user record, such as a digital wallet of the user.

More particularly, a user registers with the membership management system to create a record with the membership management system. For example, the user provides identifying information, such as a name, address, telephone number, and/or email address of the user. The user may also provide financial payment account information, such as a credit card number, to the membership management system. Based on the information that membership management system receives from the user, the membership management system establishes a record, such as a digital wallet account, with the membership management system. The user can then use the digital wallet account when shopping for products or services as described herein.

After the membership management system establishes an account for the user, the membership management system receives a request from the user to associate membership accounts of the user with the user record. For example, the user may identify one or more specific merchants for which the user has a loyalty account. Alternatively, the user may request that the membership management system automatically determines the user's loyalty memberships or other membership accounts among a group of unspecified merchants. For example, the user may ask the membership management system to “automatically identify all my loyalty accounts for me.”

In response to the user's request, the membership management system determines an identifier for the user. For example, the membership management system may employ the user's telephone number or email address as the user identifier. The membership management system then communicates the user identifier to one or more merchants. For example, the membership management system may communicate the user's telephone number (as the user identifier) to a specific merchant that the user has identified and/or to multiple, unspecified merchants. In certain examples, such as when multiple users in the same household are associated with the same telephone number, the membership management system may also communicate additional information along with the user identifier, such as the particular user's name that has registered with the membership management system.

After receiving the user identifier and/or any other information of the user, the merchant determines whether the user has a membership account, such as a loyalty account or other membership, with the merchant. If so, the merchant communicates the membership account information, such as the user's loyalty account number, to the membership management system. The membership management system receives the membership account information for the user and then associates the user's membership information—such as the user's loyalty membership number—with the record for the user.

By relying on the methods and systems disclosed herein, the membership management system can—on behalf of the user—automatically associate one or more user membership accounts with a record for the user, such as with the user's digital wallet account. Hence, the methods and systems described herein allow the user to conveniently store all of his or her account memberships, including loyalty account memberships, in one place. The user can then provide the user's membership account information for a particular merchant when completing a purchase transaction with the particular merchant.

### Example System Architectures

Turning now to the drawings, in which like numerals indicate like (but not necessarily identical) elements throughout the figures, example embodiments are described in detail.

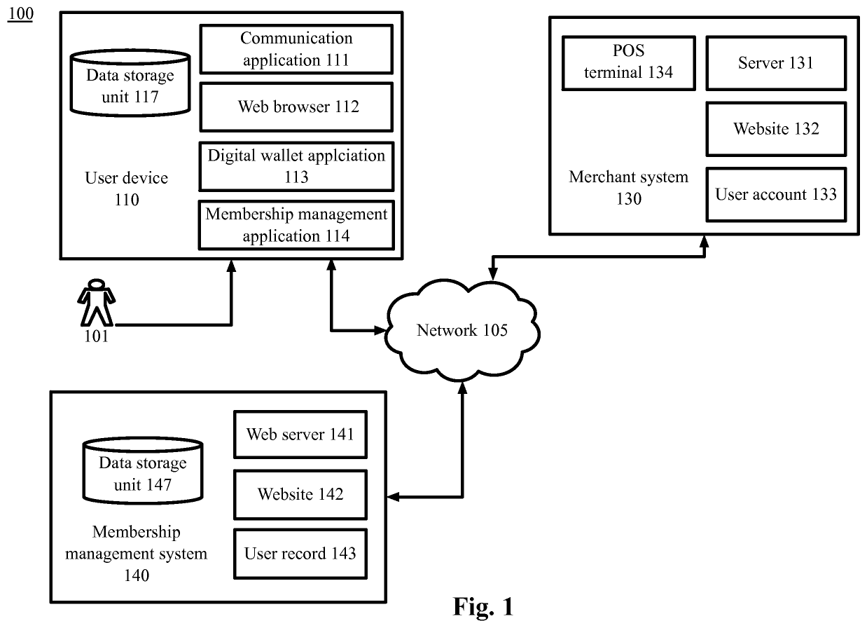

FIG. 1 is a block diagram depicting a system 100 for managing a membership account of a user, in accordance with certain example embodiments.

As depicted in FIG. 1, the exemplary operating environment 100 includes a user network computing device 110, a merchant computing system 130, and a membership management system 140 that communicate with each other via one or more networks 105. In another example embodiment, two or more of these computing systems (including systems 110, 130, and 140) or parts thereof are integrated into the same system. In certain example embodiments, a user 101 associated with a user device 110 must install an application and/or make a feature selection on the user device 110 to obtain the benefits of the methods and techniques described herein. Additionally or alternatively, the user 101 may obtain the benefits of the methods and techniques described herein via a web-based application.

Each network 105 includes a wired or wireless telecommunication means by which network devices (including devices 110, 130, and 140) can exchange data. For example, each network 105 can include a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, Bluetooth, near field communication (NFC), or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 130, and 140 includes a device having a communication module capable of transmitting and receiving data over the network 105. For example, each network device 110, 130, and 140 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110, 130, and 140 are operated by end-users or consumers, merchant system operators, and membership management system 140 operators, respectively.

The user 101 can employ a communication application 111, such as a web browser 112 application or a stand-alone application, to view, download, upload, or otherwise access documents or web pages via a distributed network 105. The communication application 111 of the user computing device 110 can interact with web servers or other computing devices connected to the network 105. For example, the communication application 111 can interact with the user network computing device 110, the merchant system 130, and/or membership management system 140. The web browser 112, for example, may also provide a user interface for accessing other devices associated with the network 105.

The user computing device 110 may include a digital wallet application 113. The digital wallet application 113 may encompass any application, hardware, software, or process the user computing device 110 may employ to assist the user 101 in completing a purchase transaction. The digital wallet application 113 can interact with the communication application 111 or can be embodied as a companion application of the communication application 111. As a companion application, the digital wallet application 113 can execute within the communication application 111. That is, the digital wallet application 113 may be an application program embedded in the communication application 111, for example.

In certain example embodiments, the user computing device 110 may also include a membership management application 114. The membership management application 114, for example, communicates and interacts with the membership management system 140, such as via the communication application 111 and the network 105. To obtain the benefits of the membership management system 140 as described herein, for example, a user 101 may have to download and install the membership management application 114 on the user device 110. The membership management application 114, for example, may be configured, based on user preferences, to obtain, receive, and communicate information of the user 101 to the membership management system 140.

In certain example embodiments, the membership management application 114 can interact with the digital wallet application 113 or can be embodied as a companion application of the digital wallet application 113. As a companion application, the membership management application 114 can execute within the digital wallet application 113. That is, the membership management application 114 may be an application program embedded in the digital wallet application 113, for example. In certain example embodiments, the membership management application 114 executes and operates independently of the digital wallet application 113.

The user computing device 110 may also include a data storage unit 117. The example data storage unit 117 can include one or more tangible computer-readable storage devices. The data storage unit 117 can be a component of the user device 110 or be logically coupled to the user device 110. For example, the data storage unit 117 can include on-board flash memory and/or one or more removable memory cards or removable flash memory.

The merchant computing system 130 (or “merchant”) represents a system that offers products and/or services for the user 101 to purchase or use and/or that provides or manages rewards for a user 101. In certain example embodiments, the merchant system 130 includes a point-of-sale (“POS”) terminal 134. The point-of-sale terminal 134 may be a physical location, for example, that is operated by a salesperson that enters purchase data into the point-of-sale terminal 134 to complete a purchase transaction. Affiliated or associated with the merchant system 130 is a merchant system operator (not shown). The merchant system operator, for example, may configure the merchant system 130 to provide offers for products.

The merchant computing system 130 may also include a merchant server 131, which in certain example embodiments may represent the computer-implemented system that the merchant system 130 employs to create and assemble a website 132 and content for the website 132, such as offers for products of the merchant system 130. In certain example embodiments, the website 132 provides a user interface for users 101 to purchase products online from the merchant system 130. The merchant computing system 130 may also include a user account 133, for example, that operates as a record for membership accounts, such as loyalty accounts, that users may have established with the merchant computing system 130. That is, the user account 133, such as a user loyalty account or other membership account particular to the user, may operate to store user account membership information for one or more users 101 with the merchant system 130.

The membership management system 140 represents a system that, in certain example embodiments, determines user account memberships on behalf of a user as described herein. The membership management system 140 also represents a system that, for example, automatically associates a user's account memberships with a record 143 for the user 101. The membership management system 140 may interact with the user device 110 and the merchant system 130 via the network 105. For example, the membership management system 140 may communicate and interact with the membership management application 114 of the user device 110 via the network 105.

The membership management system 140 may include a server 141, which represents the computer-implemented system for determines user account memberships on behalf of a user as described herein. The membership management system 140 may also include a website 142 that, for example, provides a user interface (not shown) for a user to access the membership management system 140. For example, a user 101 may employ the website 142 to register and create a user record 143 with the membership management system 140 as described herein.

The membership management system 140 may also include an accessible data storage unit 147. For example, the data storage unit 147 may store received user information associated with the user record 143 of the user 101. The exemplary data storage unit 147 can include one or more tangible computer-readable media. The data storage unit 147 can be stored on the user device 110 or can be logically coupled to the user device 110. For example, the data storage unit 147 can include on-board flash memory and/or one or more removable memory cards or removable flash memory. Additionally or alternatively, the membership management system 140 may rely on a separate, cloud-based storage system or device.

In certain example embodiments, the account management functions of the membership management system 140 operate and execute fully and completely on the user device 110, such as within, or as a companion application to, the membership management application 114. Alternatively, membership management functions of the membership management system 140 may operate and execute separately and independently from the user device 110. For example, the membership management system 140 may operate and execute within a separate computing system or other computing system that manages account memberships as described herein. Alternatively, in other example embodiments, the account management functions of the account management system 140 may execute partially on the user device 110 and/or partially on a separate computing system. For example, the account management functions of the account management system 140 occur both via the membership management system 140 and the membership management application 114.

It will be appreciated that the network connections shown are example and other means of establishing a communications link between the computers and devices can be used. Additionally, those having ordinary skill in the art and having the benefit of the present disclosure will appreciate that the user device 110, merchant system 130, and the membership management system 140 in FIG. 1 can have any of several other suitable computer system configurations. For example, a user computing device 110 embodied as a mobile phone or handheld computer may not include all the components described above.

### Example Processes

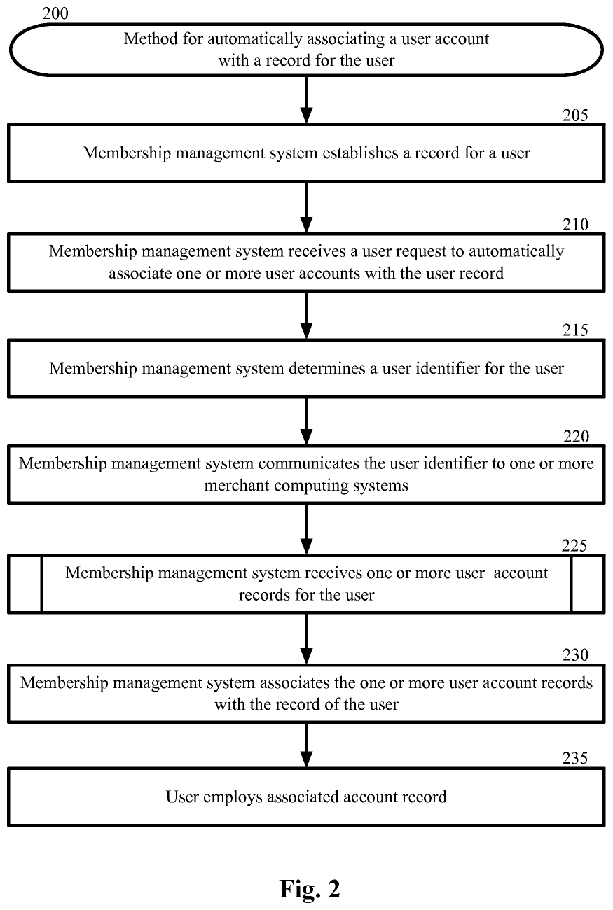

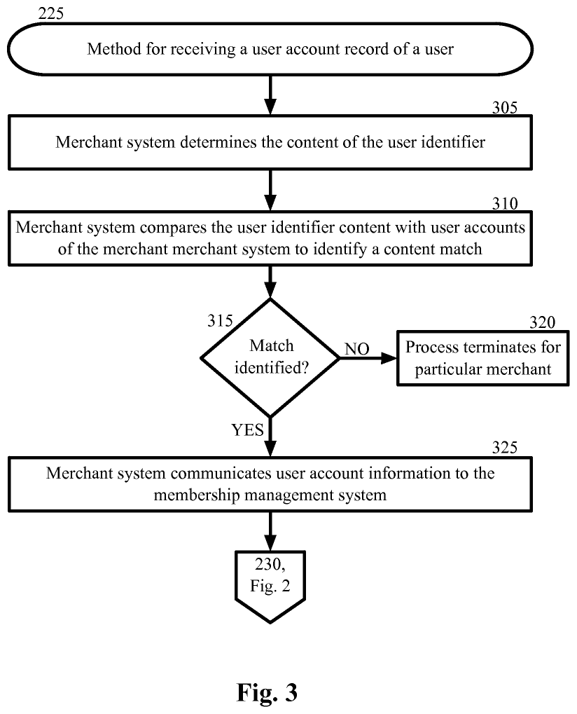

The components of the example operating environment 100 are described hereinafter with reference to the example methods illustrated in FIGS. 2-3.

FIG. 2 is a block flow diagram depicting a method 200 for automatically associating a user account 133, such as a loyalty account or other membership account, with a record 143 for the user 101.

With reference to FIGS. 1 and 2, in block 205, the membership management system 140 establishes a record 143 for a user 101. That is, a user 101 registers with the membership management system 140, such as by providing information to the membership management system 140, that allows the membership management system 140 to create a record 143 (account) for the user 101. For example, the user 101, such as via a web browser 112 on the user device 110, may access the website 142 of the membership management system 140 to provide registration information. Such information may include, for example, the user's name, address, e-mail address, billing address, shipping address, telephone number, social security number (or portion thereof), driver's license number, personal identification number, and/or other user-specific information. The membership management system 140 may also establish log in credentials for the user 101 so that the user 101 can access the user record 143. For example, the membership management system 140 may, based on information from the user 101, establish a username and password that the user 101 can employ to securely access the user record 143. In certain example embodiments, the user 101 may provide registration information indirectly to the membership management system 140, such as when creating an account such as a digital wallet account with another computing system (not shown). The membership management system 140 can then employ the received user information to create or establish the user record 143 as described herein.

In certain example embodiments, the user 101 may also provide the name of one or more specific merchants for which the user 101 has a membership account. As used herein, the “membership” or “membership account” can include any account of the user 101 that is used in connection with any products and/or services provided to or related to the user 101. For example, the membership account may include a gym membership, a membership in a frequent flyer program, or membership in a retailer such as a volume or discount wholesaler. The membership account may also include any type of loyalty account, loyalty membership, or loyalty program or system that maintains a record of user transactions with owner or issuer of the account. For example, a particular merchant 130 and a user 101 may rely on an account 133, such as a loyalty account, with the merchant 130 to maintain a record of user purchase transactions with the particular merchant 130. Hence, by using the user account 133, the user 101 does not have to keep paper receipts, for example, to make returns. Rather, the user 101 may rely on stored purchase transaction information associated with the user account 133 to process returns.

Additionally or alternatively, a merchant may employ the user account 133 to provide user rewards to the user 101—such as points, credits, discounts, or other offers or rewards—that the user 101 can redeem with the merchant 130. For example, the reward can be any type of offer, such as a ticket, coupon, discount, rebate, voucher, special offer, prepaid offer, or any other type of promotion that the user 101 can exchange with the merchant 130 for a financial discount or rebate when purchasing a product or service. For online retailers or merchants 130, for example, the reward may be any type of coupon code, promotional or promo code, discount code, key code, reward code, or any other type code exchanged for a financial discount or provided to the user 101. The reward may also be a frequent flyer mile or miles or other redeemable option associated with a frequent flyer program. Additionally or alternatively, the merchant may employ the user account 133 to allow the user 101 access to the merchant, such as when the merchant requires a membership to purchase products and/or services from the merchant.

In certain example embodiments, when registering with the membership management system 140, the user 101 may associate one or more financial accounts with the user record 143 so that the user 101 can use the user record 143 when making purchases. For example, the user 101 may associate with the user account 143 bank account debit cards, credit cards, gift cards, stored value cards, prepaid cards, or any other type of financial account that the user 101 can employ to make a purchase with a merchant 130. The user 101 may also provide or select rules for the user record 143, such as which specific financial account the membership management system 140 is to use when the user 101 makes a purchase using the user record 143. In certain example embodiments, the user account 143 is associated with an account number, which the user 101 can provide to a merchant system 130 when making a purchase transaction. Hence, in certain example embodiments, the user record 143 of the membership management system 140 may operate as a digital wallet account of the user 101.

To obtain the benefits of the methods and techniques herein, the user 101—when creating the user record 143 with the membership management system 140—may have to select a setting or install an application on the user device 110. For example, the user may have to install a digital wallet application 113 and/or a membership management application 114 on the user 101. Additionally or alternatively, the user 101 may login in to the membership management system 140 via the website 142 of the membership management system 140. In certain example embodiments, when registering with the membership management system 140 system, the user 101 may configure the membership management system 140 automatically associate one or more user accounts 133 with the user record 143 at specific times. For example, the user 101 may select a setting, for example, that triggers automatic association of one or more user accounts 133 with the membership management system 140 as defined intervals, such as once a week, once per month, or once per year.

In block 210, the membership management system 140 receives a user request to automatically associate one or more user accounts 133 with the user record 143. That is, the membership management system 140 receives an indication from the user 101 that the user 101 desires the membership management system 140 to automatically associate one or more user accounts 133 with the user record 143. In certain example embodiments, the user's registration with the membership management system 140 may operate as a request to automatically associate user accounts 133 of the user 101 with the membership management system 140. Hence, the membership management system 140 may not receive a separate request or indication of the user 101 to automatically associate user accounts 133, such as user accounts or other membership accounts, of the user 101 with the membership management system 140.

In certain example embodiments, the user—when registering with the membership management system 140—may select an option, such as a user control option, to automatically associate one or more of the user's accounts 133 with the user record 143. In certain example embodiments, the user control option may be a button on the website 142 of the membership management system 140, such as an “associate membership accounts now” button. Selection of the option, such as by clicking or otherwise selection the user control option, indicates that the user 101 intends the membership management system 140 to associate the user's one or more user accounts 133 with the membership management system 140.

Additionally or alternatively, such as when the user 101 has identified specific merchants 130 for which the user 101 may have a user account 133, the membership management system 140 may provide an option to associate accounts 133 of the identified merchants 130 with the user record 143. For example, the membership management system 140 may provide a user control option on the website 142—such as a “associate membership accounts for identified merchants now” button—that allows the user 101 to request association of user accounts 133 for identified merchants with the membership management system 140. In other words, selection of the option, such as by clicking or otherwise selection the user control option, indicates that the user 101 intends the membership management system 140 to associate the user's one or more user accounts 133—of the identified merchant—with the membership management system 140.

In certain example embodiments, the user 101 may notify the membership management system 140 when the user establishes a new user account 133. For example, the user 101 may email and/or text the membership management system 140 the name of a merchant 130 for which the user 101 has recently established a new user account 133 such as a loyalty account. Additionally or alternatively, user 101 may log in to the user account 143 and provide the name of the merchant 130 for which the user 101 has recently established a new account 133. In such example embodiments, receiving the name of the merchant 130 may operate as a request (or indication) that the user 101 intends the membership management system 140 to automatically associate the new user account 133 the membership management system 140 as described herein.

In block 215, the membership management system 140 determines a user identifier for the user 101. That is, in order to automatically associate one or more user accounts 133 of a user 101 with the membership management system 140, the membership management system 140 reads the content of the user record 143 to determine specific, user-provided information that the membership management system 140 may employ to identify user accounts 133 of the user 101 as described herein.

The user identifier can be any discrete information relating to a particular user 101, such as user-provided information received during the user's registration with the membership management system 140. For example, by reading the user record 143, the membership management system 140 may identify the telephone number of the user 101 as the user identifier. In certain example embodiments, the user identifier may include both the user's telephone number of the user 101 as well as the user's first name, last name, or first and last name. The user identifier may also include, for example, the last four digits of the user's social security number, all or part of the user's driver's license number or personal identification number, and/or the user's email address (or any other user-specific information). In certain example embodiments, the identifier include any other information regarding the user 101, such as information associated with the user's social network. For example, the membership management system 140 may determine address information for the user 101 based on the user's social network profile.

In block 220, the membership management system 140 communicates the determined user identifier to one or more merchant computing systems 130. That is, after determining the user identifier, the membership management system 140 transmits the user identifier to one or more merchant computing systems 130, such as via the network 105. The merchant computing system 130 then receives the user identifier via the network 105. For example, if the user identifier includes the user's telephone number, the membership management system 140 transmits the user identifier—including the user's telephone number—to one or more merchant computing systems 130. If, for example, the user identifier includes additional information about the user 101, such as all or part of the user's name, the membership management system 140 communicates the additional information to the merchant system 130 via the network 105, and the membership management system 140 receive the information via the network 105.

The merchant computing system 130 receiving the user identifier can be any merchant 130 that maintains user accounts 133 on behalf of one or more users 101. For example, the merchant 130 may be a retailer that provides loyalty accounts for its customers. The merchant 130 may also be a retailer, wholesaler, or other business entity that requires user membership to access the retailer or entity. For example, the merchant may be a gym to which the user 101 belongs or a movie rental storefront where the user 101 rents movies of games. In certain examples, the merchant system 130 may include a specific merchant 130 that the user identifies, such as during registration with the membership management system 140 as described herein. Additionally or alternatively, the merchant system 130 may include a merchant that the user 101 has not identified, but that nevertheless maintains one or more user accounts 133 for the user 101.

As used herein, the “merchant” or “merchant computing system” 130 may, in certain example embodiments, include and/or be associated with an account service provider (not shown), such as a loyalty account management service, that manages user accounts 133 on behalf of the merchant system 130. For example, when a user 101 establishes a user account 133 with the merchant system 130—either at a merchant point of sale terminal 134 and/or a merchant website 143—the merchant system 130 may communicate the user account information to the service provider.

After receiving the user account information, the service provider can then processes any subsequent user activity associated with the user account 133. For example, the service provider may receive and process purchase transaction information between the user 101 and the merchant 130 and thus apply any rewards or other items due to the user 101 in accordance with policies and procedures of the user account 133. Hence, in addition or alternatively to communicating the user identifier to one or more merchants, the membership management system 140 may—in certain example embodiments—communicate the user identifier directly and/or indirectly to the one or more account service providers. The service provider may then determine a user account record 143 for the user 101 as described herein.

In block 225, the membership management system 140 receives one or more user account records for the user 101. That is, after the merchant computing system 130 receives the user identifier from the membership management system 140, the merchant system 130 relies on the user identifier to identify the user account 143 corresponding to the particular user 101. The merchant system 130 then determines the user's account number, for example, and then communicates the account number to the membership management system 140. The details of block 225 are described in further detail below with reference to FIG. 3.

FIG. 3 is a block flow diagram depicting a method 225 for receiving a user account record of a user, as referenced in block 225 of FIG. 2.

With reference to FIGS. 1 and 2, in block 305 of method 225, the merchant system 130 determines the content of the user identifier. That is, after receiving the user identifier from the membership management system 140, the merchant system 130 reads the received identifier to determine the information contained in the user identifier. For example, if the user identifier contains the telephone number of the user, the merchant system 130 determines—from the user identifier—the user's telephone number. If the user identifier also includes the user's first and last name, for example, the merchant system 130 may determine the user's first and last name based on reading and determining the content of the user identifier.

In block 310, the merchant system 130 compares the user identifier content with user accounts 133 of the merchant system 130 to identify a content match. For example, if the merchant system 130 determines the telephone number of a particular user based on the content of the user identifier, the merchant system 130 compares the user's telephone number with telephone numbers associated with the user accounts 133 of the merchant system 130. If the merchant system 130 determines a telephone number associated with user account 133 that matches the telephone number associated with the user identifier, the merchant system 130 identifies a content match between the user identifier and the user accounts 133 of the merchant 130.

Additionally or alternatively, if the user identifier includes the last four digits of the user's personal identification number, for example, the merchant system 130 compares the last four digits of the user's personal identification number with the personal identification numbers associated with the user accounts 130 of the merchant system 130. The merchant system 130 identifies a match, for example, if the merchant system 130 determines a personal identifier in the user accounts 133 of the merchant system 130 that matches the last four digits of the user's personal identification number in the user identifier.

In certain example embodiments, multiple user accounts 133 may be associated with a single telephone number. For example, when establishing a user account 133, such as a user loyalty account, with a particular merchant 130, three users residing at the same address may provide the same telephone number to the merchant 130, which the merchant then associates with a separate user account 133 for each of the three users 101. In such embodiments, the merchant system 130 may rely on any additional information associated with the user identifier to identify a match for the user identifier.

For example, if the user identifier includes a user's first and/or last name, the merchant system 130 may compare the user's first and/or last name with the first and last names of user's associated with the user accounts 133 of the merchant system 130 to distinguish among the multiple, identified user accounts 133. That is, if the merchant system 130 identifies three user accounts 133 based on the telephone number included in the user identifier, the merchant system 130 may rely on the first name of the user to determine which of the three identified accounts correspond to the user 101 associated with the received user identifier. In other words, if Alex, Bob, and Cathy each have identified loyalty accounts, for example, that correspond to the same telephone number—but the user identifier also includes the name “Cathy”—then the merchant system 130 determines that the user identifier corresponds specifically to Cathy (and hence Cathy's loyalty account). In certain example embodiments, the merchant system 130 may use other information—such all or portions of personal identification numbers and/or drivers license numbers—to distinguish among multiple users.

In certain example embodiments, when multiple user accounts 133 are associated with a single user identifier (such as a telephone number) as described herein, the merchant 130 may request additional information from the membership management system 140 so that the merchant 130 can distinguish among the multiple users 101 associated with the user identifier. For example, the merchant system 130 may request—from the membership management system 130—the name of the particular user 101 associated with the user identifier. In certain example embodiments, the membership management system 130 may also request additional information from the user 101 associated with the user record 143, so that the membership management system 130 can provide information to the merchant 130 that distinguishes the user 101 from other users associated with a user-provided telephone number, for example.

If a particular merchant system 130 determines a content match between the content of the user identifier and a user account 133, the method follows the “YES” branch of block 315 to block 325, in accordance with certain example embodiments. But if the merchant system 130 does not determine a content match between the content of the user identifier and a user account 133, the methods method follows the “NO” branch of block 315 to block 320, in accordance with certain example embodiments.

In block 320, when a particular merchant does not identify a user account corresponding to the content of the user identifier, the process—for the particular merchant—terminates. For example, the user 101 may not have ever established a user account 133 with the particular merchant 130. Hence, the particular merchant may have no user account 133 records, for example, that the particular merchant can communicate to the membership management system 140 as described herein. The process for the particular merchant system 130 attempting to match the user identifier content with the user accounts 130 for the merchant 130 thus terminates.

In block 325, when a particular merchant 130 identifies a user account 133 corresponding to the content of the received user identifier, the merchant system 130 communicates the user account information to the membership management system 140. For example, based on the user account 133 that the merchant system 130 identifies by comparing the user identifier to the user account 133 records of the merchant system 130, the merchant system 130 determines a user account record for the user 101, such as the membership account number associated with the identified user account 133. The merchant system 130 then communicates the record for the user's user account 133 to the membership management system 140, such as via the network 105. The membership management system 140 then receives the user account record for the user via the network 105.

In certain example embodiments, such as if the merchant system 130 identifies multiple users 101 corresponding to the user identifier but is unable to distinguish among the different user accounts 133, the merchant system 130 may communicate information for the multiple, identified user accounts 133 to the membership management system 140. For example, the merchant system 130 may communicate user account numbers for three different accounts, along with the first name of the user 101 associated with the each account. Upon receipt of such information, for example, the membership management system 140 may compare the received user account information with the user record 143 from which the membership management system 140 derived the user identifier. For example, the merchant system 130 may communicate three user account membership numbers—corresponding to users Dale, Edward, and Frank, respectively—to the membership management system 140. If the membership management system 140 determines that the user record 143 from which the membership management system 140 derived the user identifier belongs to Dale, the membership management system 140 determines that the received user account information corresponding to Dale is the correct account membership number for Dale.

Returning to FIG. 2, in block 230 of FIG. 2, the membership management system 140 associates the one or more user account records with the record 143 of the user 101. That is, after receiving the account record for the user 101, such as user's account membership number, the membership management system 140 includes the received record in the user record 143. For example, the membership management system 140 inputs the user's account membership number in to the user record 143 on behalf of the user 101. The user 101 can then access the account membership number, for example, such as when making a purchase via a financial payment account associated with the user record 143 as described herein.

In certain example embodiments, the methods and systems described herein in blocks 205-230 may be repeated for multiple merchants 130. That is, the membership management system 140 may, on behalf of the user 101, automatically associate user account records with the record 143 of the user 101 for multiple, different merchants. Hence, by utilizing the methods and systems described herein, the membership management system 140 can conveniently and automatically manage account memberships of the user 101 on behalf the user 101. The user can then employ the associated account record 143, for example, to keep track of the user's loyalty rewards, purchases, and memberships.

In block 235, the user 101 employs the account record 143. That is, the user 101 uses the record 143—and hence the membership account associated therewith—such as when making a purchase at a merchant 130. For example, when making a purchase at a merchant point-of-sale terminal 134, the user 101 may access the digital wallet application 113 on the user device 110 to retrieve the record 143 for the user. The user 101 may then present the record 143 to an operator of the merchant point-of-sale terminal 143. The operator of the merchant point-of-sale terminal 143 can then obtain (receive) the user's membership account number—for the particular merchant 130—that is associated with the record 143. If the account is a loyalty account, for example, the merchant 130—via the loyalty membership account information received at the merchant point-of-sale terminal 143—can then process any rewards for the user 101 pertaining to the purchase transaction.

### Other Example Embodiments

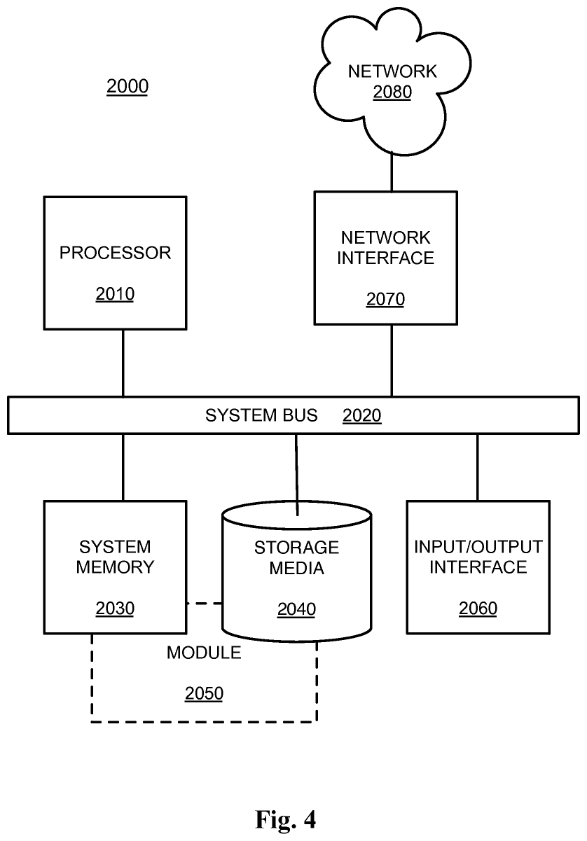

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer implemented method to manage merchant-specific memberships of users in electronic wallets, comprising:
determining, by one or more computing devices, a user identifier associated with a record of the user based on a set of information in the record;
in response to determining the user identifier, automatically updating, by the one or more computing devices and on behalf of the user, an electronic wallet of the user, the automatic update of the electronic wallet comprising,
communicating, by the one or more computing devices, the user identifier to one or more merchant computing systems, wherein the one or more merchant computing systems are separate from the one or more computing devices;
in response to communicating the user identifier to the one or more merchant computing systems, receiving, by the one or more computing systems from a particular merchant system, a plurality of membership records, each membership record associated with a different user, and each membership record corresponding to the identifier;
determining, by the one or more computing devices and based on the set of information in the record, the received membership record associated with the first user from among the received membership records; and
associating, by the one or more computing systems and on behalf of the user, the determined membership record with the electronic wallet of the user.

2. The method of claim 1, further comprising receiving, by the one or more computing systems, a request from a user computing device of the user to automatically update the electronic wallet of the user on behalf of the user.

3. The method of claim 1, wherein automatically updating the electronic wallet of the user further comprises determining, by the one or more computing systems, an identity of the one or more merchant systems.

4. The method of claim 3, wherein determining the identity of the one or more merchant systems comprises, receiving, by the one or more computing devices and from a user computing device of the user, an identity of one or more particular merchant systems.

5. The method of claim 1, wherein the user identifier comprises a telephone number associated with the user.

6. The method of claim 5, wherein the user identifier further comprises the user's name, address, e-mail address, or a portion thereof.

7. The method of claim 1, wherein the record of the user comprises a financial payment account of the user.

8. The method of claim 1, wherein receiving the plurality of membership records for the user comprises:
receiving, by the one or more merchant computing systems, the user identifier;
identifying, by the more merchant computing systems, a particular membership record for the user based on the user identifier; and
in response to identifying a membership record for the user, communicating, by one or more merchant computing systems, the membership record to the one or more computing devices.

9. A system to manage merchant-specific memberships of users in electronic wallets, comprising:
a storage device;
a processor communicatively coupled to the storage device, wherein the processor executes application code instructions that are stored in the storage device to cause the system to:
determine a user identifier associated with a record of the user based on a set of information in the record;
communicate the user identifier to one or more merchant computing systems;
in response to communicating the user identifier to the one or more merchant computing systems, receive, from a particular merchant system, a plurality of membership records, each membership record associated with a different user, and each membership record corresponding to the user identifier;
determine, based on the set of information in the record, the received membership record associated with the first user; and
automatically associate, on behalf of the user, the determined membership record for the user with an electronic wallet of the user.

10. The system of claim 9, further comprising determining an identity of the one or more merchant systems.

11. The system of claim 10, wherein determining the identity of the one or more merchant systems comprises, receiving, from a user computing device of the user, an identity of one or more particular merchant systems.

12. The system of claim 9, wherein the user identifier comprises a telephone number associated with the user.

13. The system of claim 12, wherein the user identifier further comprises the user's name, address, e-mail address, or a portion thereof.

14. The system of claim 9, wherein the record of the user comprises a financial payment account of the user.

15. The system of claim 9, wherein receiving the plurality of membership records for the user comprises:
receiving, by the one or more merchant computing systems, the user identifier; and
identifying, based on the received user identifier, a membership record for the user.

16. A computer program product, comprising:
a non-transitory computer-readable storage device having computer-executable program instructions embodied thereon that when executed by a computer cause the computer to manage merchant-specific memberships of users in electronic wallets, the computer-executable program instructions comprising:
computer-executable program instructions to determine a user identifier associated with a record of the user based on a set of information in the record;
computer-executable program instructions to automatically update, on behalf of the user, an electronic wallet of the user, the computer-executable program instructions to automatically update the electronic wallet comprising,
computer-executable program instructions to communicate the user identifier to one or more merchant computing systems;
computer-executable program instructions to, in response to communicating the user identifier to the one or more merchant computing systems, receiving, from a particular merchant system, a plurality of membership records, each membership record associated with a different user, and each membership record corresponding to the user identifier;
computer-executable program instructions to determine, based on the set of information in the record, the received membership record associated with the first user; and
computer-executable program instructions to associate, on behalf of the user, the determined membership record with the electronic wallet of the user.

17. The computer program product of claim 16, further comprising receiving a request from a user computing device of the user to automatically update the electronic wallet on behalf of the user.

18. The computer program product of claim 16, wherein automatically updating the electronic wallet of the user further comprises determining an identity of the one or more merchant systems, wherein the merchant identity is received from the user computing device.

19. The computer program product of claim 16, wherein the user identifier comprises a telephone number associated with the user.

20. The computer program product of claim 19, wherein the membership account is a user loyalty account.
